(19) United States
(12) Patent Application Publication
(10) Pub. No.: US 2022/0327404 A1
(43) Pub. Date: Oct. 13, 2022

(54) MACHINE LEARNING TECHNIQUES FOR GENERATING RECALCULATION DETERMINATIONS FOR PREDICTED RISK SCORES

(71) Applicant: Optum, Inc., Minnetonka, MN (US)

(72) Inventors: Paul J. Godden, London (GB); Daniel George McCreary, St. Louis Park, MN (US); Gregory J. Boss, Saginaw, MI (US); Mark Gregory Megerian, Rochester, MN (US)

(21) Appl. No.: 17/382,691

(22) Filed: Jul. 22, 2021

Related U.S. Application Data
(60) Provisional application No. 63/201,041, filed on Apr. 9, 2021.

(51) Int. Cl. G06N 5/04; G06N 20/00

(52) U.S. Cl. CPC G06N 5/04; G06N 20/00

(57) ABSTRACT

Various embodiments of the present invention provide methods, apparatus, systems, computing devices, computing entities, and/or the like for performing risk score generation predictive data analysis. Certain embodiments of the present invention utilize systems, methods, and computer program products that perform risk score generation predictive data analysis by utilizing at least one of event-based confidence scores and delay-based confidence scores.

### CROSS-REFERENCES TO RELATED APPLICATION(S)

The present application claims priority to U.S. Provisional Patent Application No. 63/201,041 (filed Apr. 9, 2021), which is incorporated herein by reference in its entirety.

### BACKGROUND

Various embodiments of the present invention address technical challenges related to performing predictive data analysis and provide solutions to address the efficiency and reliability shortcomings of existing predictive data analysis solutions.

### BRIEF SUMMARY

In general, various embodiments of the present invention provide methods, apparatus, systems, computing devices, computing entities, and/or the like for performing risk score generation predictive data analysis. Certain embodiments of the present invention utilize systems, methods, and computer program products that perform risk score generation predictive data analysis by utilizing at least one of event-based confidence scores and delay-based confidence scores.

In accordance with one aspect, a method is provided. In one embodiment, the method comprises: determining, based at least in part on a recalculation delay value for a recalculation delay period that is associated with a target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category; determining, based at least in part on one or more recalculation delay period events associated with the recalculation delay period, an event-based confidence score for the target temporal unit; determining a hybrid confidence score for the predicted risk score based at least in part on the delay-based confidence score and the event-based confidence score; determining a recalculation determination based at least in part on whether the hybrid confidence score satisfies a hybrid confidence score threshold; performing one or more prediction-based actions based at least in part on the recalculation determination.

In accordance with another aspect, a computer program product is provided. The computer program product may comprise at least one computer-readable storage medium having computer-readable program code portions stored therein, the computer-readable program code portions comprising executable portions configured to: determine, based at least in part on a recalculation delay value for a recalculation delay period that is associated with a target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category; determine, based at least in part on one or more recalculation delay period events associated with the recalculation delay period, an event-based confidence score for the target temporal unit; determine a hybrid confidence score for the predicted risk score based at least in part on the delay-based confidence score and the event-based confidence score; determine a recalculation determination based at least in part on whether the hybrid confidence score satisfies a hybrid confidence score threshold; perform one or more prediction-based actions based at least in part on the recalculation determination.

In accordance with yet another aspect, an apparatus comprising at least one processor and at least one memory including computer program code is provided. In one embodiment, the at least one memory and the computer program code may be configured to, with the processor, cause the apparatus to: determine, based at least in part on a recalculation delay value for a recalculation delay period that is associated with a target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category; determine, based at least in part on one or more recalculation delay period events associated with the recalculation delay period, an event-based confidence score for the target temporal unit; determine a hybrid confidence score for the predicted risk score based at least in part on the delay-based confidence score and the event-based confidence score; determine a recalculation determination based at least in part on whether the hybrid confidence score satisfies a hybrid confidence score threshold; perform one or more prediction-based actions based at least in part on the recalculation determination.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for determining when to recalculate a predicted risk score in accordance with some embodiments discussed herein.

FIG. 5 is a flowchart diagram of an example process for determining a recalculation determination for a predicted risk score and a particular target temporal unit in accordance with some embodiments discussed herein.

FIG. 6 is a flowchart diagram of an example process for determining an event-based confidence score for a predicted risk score with respect to a target temporal unit in accordance with some embodiments discussed herein.

FIG. 7 provides an operational example of a set of event weights for a set of recalculation delay period events in accordance with some embodiments discussed herein.

FIG. 8 is a flowchart diagram of an example process for determining a hybrid confidence score based at least in part on a delay-based confidence score and an event-based confidence score in accordance with some embodiments discussed herein.

FIG. 9 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Improvements

Various embodiments of the present invention improve the computational efficiency of performing risk score generation predictive data analysis by reducing the need for continuous generation of predicted risk scores. For example, various embodiments of the present invention introduce techniques to determine when to optimally recalculate predicted risk scores by using hybrid confidence scores for predicted risk scores based at least in part on delay-based confidence scores for the predicted risk scores and event-based confidence scores for the predicted risk scores. By using the noted techniques, various embodiments of the present invention reduce the number of times predicted risk scores need to be calculated, a feature that in turn avoids the need for some computational operations configured to recalculate predicted risk scores, and in doing so vastly improves the computational efficiency of performing risk score generation predictive data analysis by reducing the need for continuous generation of predicted risk scores.

An exemplary application of various embodiments of the present invention relates to determining when to calculate polygenic risk scores (PRSs). Currently, PRSs are not in clinical use, due to limitations in accuracy and clinical utility, and the fact that PRS is currently more effective for certain diseases than others. The nature of a PRS is that it is a population-level measure that is being attempted to be utilized on a personal level, and this is where the concept of an integrated risk score naturally arises. In many clinically-relevant circumstances, the essentially static nature of a patient's genetic risk profile is far less important than the combination of PRS with other risk factors. For example, a patient may have a genomic profile that is strongly indicative of an elevated lifetime risk of non-small cell lung cancer (NSCLC). However, the key factor that may determine the risk trajectory for NSCLC is the length of time and the number of cigarettes he or she smokes. Smoking cessation will reduce the risk profile enormously, even though the inherent genetic risk remains the same. This indicates that an integrated risk score, combining behavioral, clinical, genetic, social determinants of health and other relevant factors for the disease in question would be of great utility in improving patient care.

This leads to the realization that an integrated risk score is not necessarily fixed, and that the PRS is just one component. Certain circumstances may significantly alter the overall risk score, either beneficially or detrimentally—as per the smoking example above. Therefore, the ability for the risk prediction system to be able to estimate the timescale over which the risk score is likely to remain valid, or to require an update due to significant non-genetic changes, would be a valuable addition to any type of integrated risk scoring tool.

Aspects of various embodiments of the present invention seek to address the above-noted challenges by adding functionality to the integrated clinical-PRS graph ensemble to detect, and then alert a care provider, when the integrated risk score determined for a specific patient may become stale and in need of re-calculation. Typically, the recalculation will take one of two forms (or a combination of both): using a data-driven identification or through event-driven circumstances. The latter approach can also include determination of the absence of an event of clinical relevance. For example, if a patient is confirmed as having a total response to his/her chemotherapy, but the particular type of tumor has a high recurrence rate (such as Ta or Tis stage bladder cancers), then the time period for risk scoring will be via expert clinical recommendations that are consist with usual “watch and wait” surveillance strategies for that particular disease. However, certain reported clinical events, such as hematuria subsequent to remission of bladder cancer, may result in the solution determining that a refresh of the risk score be updated, even if the duration of the time period since the last risk score is within the threshold. Time-period and/or event-driven analysis frameworks can be determined by collaboration with clinical experts, to initialize the system. From this point onwards, decisions made are determined from data, and are thus individualized so that the refresh is determined per patient.

One example of series of complex clinical events would be calculation of potential hemorrhage risk for a patient who is being commenced on anticoagulant therapy. An integrated risk score would be calculated for that patient, and then the system would further detect indications that the patient may have a previous undiagnosed condition of factor V Leiden, due to a strong family history of abnormal blood clots, as determined based at least in part on the patient's electronic medical record (EMR) data. In addition to international normalized ratio (INR) values, acquired via blood draws, some embodiments of the invention determine that a genetic panel may then be recommended, either in addition to or instead of an activated protein C blood test. The confirmation of a type of factor V Leiden may then determine that the time period associated with an refresh of the hemorrhage risk score calculation is shortened. This may, in turn, be modified if the patient is following physician recommendations (e.g., wearing compression stockings to minimize blood clot risk).

Conversely, for certain conditions, the event-driven aspect may be deemed not important. For certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and his/her age, and thus the time period since the initial risk score is the most likely factor.

The event-driven attributes may be derived from clinical encounter data, for example clinical encounter data regarding a specific patient's insulin adherence may relate to his/her elevated H1AC score. This could imply that the risk score for this patient needs to be updated every 6 months, as there could be significant changes in his/her risk profile if his/her adherence becomes noncompliant. For a second patient however, who is non-diabetic, a model may recommend updating integrated risk scores yearly, as there is no equivalent medication adherence feature in the corresponding risk tensor data. In some cases, the system may determine that the genetic component of the overall risk score be updated and enhanced by recommending that additional panels be taken. One example might be if the patient had previously had a whole-exome sequence performed but future events lead to evidence that suggests, for his/her condition, there may be the possibility of a pathogenic variant of significance in a non-coding region of his/her genome; another example would be the analysis of a tumor genome for, e.g., the presence of acquired resistance single nucleotide polymorphisms (SNPs) to first-generation Tyrosine Kinase Inhibitor (TKI) drugs.

As an added benefit, facilitating integrated risk score refresh might change behavior via clinical intervention, and thus reduce the cost of care and improve outcomes for the patient. This could occur because a recalculation of the risk score might change behaviors or initiate early intervention. Over a long period of time, including many recalculations of the integrated risk score, a time series analysis of the risk scores would provide suggestions for varying the risk trajectory by suggesting how different treatments and behaviors can the patient's actual risk through measurement of his/her clinical attributes (e.g., blood pressure). In some embodiments, not all changes in patient's status will correspond to known risks: thus, part of the role of the integrated risk-scoring tool's update engine is to monitor all patients who have been associated with a previously-calculated risk score and ensure that all changes in condition are recorded for continual learning. For example, there is no known increase of stroke due to a patient taking Abacavir as part of multi-drug therapy. If, however, the integrated risk-scoring update engine “noticed” that a cluster of patients in a similar age group all had a stroke shortly after commencing anti-retroviral combination therapy, and all of them had taken Abacavir, then the engine would learn that this may be a novel risk factor (i.e. hitherto unknown). In scenarios like these, the engine would scan the genomic risk tensor for novel, and potentially causal, associated genetic variants. In some embodiments, various updated risks affect one another. For example, in some embodiments, a type 1 diabetic has an entry in the behavioral risk tensor regarding change of insulin compliance. This change of insulin compliance could impact multiple conditions—for example blindness, renal failure, leg ulcers, etc.—and so the integrated risk-scoring tool's rules engine may have a one-to-many recommendation, across different time scales, for re-running the entire risk calculation for several different conditions over different timescales. In some embodiments, significant changes in disease status could also trigger new risk prediction calculations. For example, if the patient develops a new condition and the integrated risk-scoring solution detects that the patient is prescribed a drug which may impact the existing condition, it will trigger a notification of potentially running an entirely new holistic score relating to that circumstance.

### II. Definitions

The term “predicted risk score” may refer to a data entity that is configured to describe a predicted risk that a monitored entity (e.g., a monitored individual) is exposed to a particular risk category (e.g., to a particular disease/condition). Examples of predicted risk scores include polygenic risk scores (PRSs) as well as inferred hybrid risk scores. In some embodiments, an inferred hybrid risk score is generated by a trained hybrid graph-based machine learning model by processing a set of graph-based feature embeddings for a corresponding patient data object. For example, the inferred hybrid risk score for a particular patient data object may be generated by processing (using a trained hybrid graph-based machine learning model) the genomic graph-based feature embedding for the particular patient data object as determined based at least in part on the genomic risk tensor for the particular patient data object, the clinical graph-based feature embedding for the particular patient data object as determined based at least in part on the clinical risk tensor for the particular patient data object, and the behavioral graph-based feature embedding for the particular patient data object based at least in part on the behavioral risk tensor for the particular patient data object. The inferred hybrid risk score may be a vector. An inferred hybrid risk score may be an input variable of an inferred hybrid risk score generation machine learning model. In some embodiments, a predictive data analysis computing entity determines a set of regressor variables for each prior patient data object of a set of prior patient data objects based at least in part on the set of prior graph-based feature embeddings for the prior patient data object. In some embodiments, using the initial candidate equations for the per-model machine learning output associated with each individual graph-based feature embeddings, the predictive data analysis computing entity determines the regressor variables. In some embodiments, the regressor variables are determined based at least in part on techniques for determining separate and interpretable internal functions as described in Crammer et al., “Discovering Symbolic Models from Deep Learning with Inductive Biases” (2020), arXiv:2006.11287v2, available online at https://arxiv.org/pdf/2006.11287.pdf. In some embodiments, a priori, a predictive data analysis computing entity over-estimates the number of regressor variables so that the algorithm can reduce the parameter space (start broad and wide, narrow down via symbolic regression to the smallest equations that match the positive class for risk) of the inferred hybrid risk score generation machine learning model.

The term “recalculation determination” may refer to a data entity that is configured to describe whether a predicted risk score for a target risk category should be recalculated at a target temporal unit (e.g., at a particular point in time) that is associated with the recalculation determination. In some embodiments, when a recalculation determination for a target risk category and a target temporal unit describes that the predicted risk score for the target risk category should be recalculated at the target temporal unit, the recalculation determination is referred to herein as an affirmative recalculation determination. In some embodiments, when a recalculation determination for a target risk category and a target temporal unit describes that the predicted risk score for the target risk category should not be recalculated at the target temporal unit, the recalculation determination is referred to herein as a negative recalculation determination. In some embodiments, a recalculation determination for a target risk category and a target temporal unit is determined based at least in part on a hybrid confidence score for the target risk category and the target temporal unit, where the hybrid confidence score for the target risk category and the target temporal unit may be determined based at least in part on a delay-based confidence score for the target risk category and the target temporal unit and an event-based confidence score for the target risk category and the target temporal unit. For example, in some embodiments, an affirmative recalculation determination is generated for a target risk category and a target temporal unit if the hybrid confidence score for the target risk category and the target temporal unit satisfies a hybrid confidence score threshold (e.g., exceeds the hybrid confidence score threshold, is above or equal to the hybrid confidence score threshold, and/or the like). As another example, a negative recalculation determination is generated for a target risk category and a target temporal unit if the hybrid confidence score for the target risk category and the target temporal unit fails to satisfy a hybrid confidence score threshold (e.g., is below or equal to the hybrid confidence score threshold, is below the hybrid confidence score threshold, and/or the like).

The term “recalculation delay period” may refer to a data entity that is configured to describe a time period between a calculation temporal unit timestamp for a predicted risk score that is associated with the recalculation delay period and a target temporal unit timestamp for a target temporal unit that is associated with the recalculation delay period. For example, if a predicted risk score is calculated on May 5, 2021, at a target temporal unit of Jul. 5, 2021, the recalculation delay period is the period between May 5, 2021 and Jul. 5, 2021, which may be associated with a recalculation delay period value of 61 days. As another example, if a predicted risk score is calculated on May 5, 2021 at 10:00 AM, at a target temporal unit of Jul. 5, 2021 of 12:00 PM, the recalculation delay period is the time period between May 5, 2021 at 10:00 AM and Jul. 5, 2021 at 12:00 PM, which may be associated with a recalculation delay period value of 61 days and two hours. In some embodiments, a recalculation delay period is associated with a recalculation delay period value that may be a measure of a length of time for the time period described by a recalculation delay period. In some embodiments, the recalculation delay period value for a recalculation delay period associated with a predicted risk score and a target temporal unit is used to determine the delay-based confidence score for the predicted risk score and the target temporal unit, where the delay-based confidence score is then in turn used to determine a hybrid confidence score for the predicted risk score and the target temporal unit.

The term “delay-based confidence score” may refer to a data entity that is configured to describe an estimated/calculated credibility score for a predicted risk score that is determined based at least in part on a recalculation delay value for a recalculation delay period that is associated with the predicted risk score and a target temporal unit. In some embodiments, the delay-based confidence score describes a degree of reduction in the credibility of a predicted risk score that is resulting from mere passage of time from the timestamp associated with calculation of the predicted risk score. In some embodiments, a delay-based confidence score for a predicted risk score and a target temporal unit is determined based at least in part on a length of time from the calculation timestamp of the predicted risk score to a timestamp of the target temporal unit. In some embodiments, a delay-based confidence score for a predicted risk score that is associated with a target risk category is determined based at least in part on a delay-based confidence scoring reduction scheme for the target risk category, as the term is defined below.

The term “delay-based confidence scoring reduction scheme” may refer to a data entity that is configured to describe, for each recalculation delay value of a set of recalculation delay values, a measure of reduction in a total hybrid confidence score for a predicted risk score given the recalculation delay value, where the total hybrid confidence score is an upper bound of a hybrid confidence score (e.g., may be a hybrid confidence score of one), and where the total hybrid confidence score is associated with a target risk category that is in turn associated with the delay-based confidence scoring reduction scheme. For example, the delay-based confidence scoring reduction scheme may describe that, for a particular target risk category (e.g., for a particular disease/condition), a one-month recalculation delay value will cause a 0.1 reduction in a total hybrid confidence score of 1.0 for predicted risk scores that are associated with the particular target risk category; and that a two-month recalculation delay value will cause a 0.2 reduction in a total hybrid confidence score of 1.0 for predicted risk scores that are associated with the particular target risk category. In some embodiments, the delay-based confidence scoring reduction scheme describes a function f(x), where x varies over a set of recalculation delay values, and f(x) describes, for each recalculation delay value, a measure of reduction in a total hybrid confidence score for a predicted risk score given the recalculation delay value. In some embodiments, a delay-based confidence scoring reduction scheme is a model that is specific to a particular target risk category, because predicted risk scores for different diseases/conditions have varying levels of susceptibility to losing relevance as a result of passage of times. For certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor.

The term “recalculation delay period event” may refer to a data entity that is configured to describe a detected/recorded event whose occurrence is deemed related to credibility of a predicted risk score. For example, an applicable recalculation delay period event for a predicted risk score that is associated with calculation of potential hemorrhage risk for a patient who is being commenced on anticoagulant therapy is detection of indications that the patient may have a previous undiagnosed condition of factor V Leiden, due to a strong family history of abnormal blood clots, from the patient's electronic medical record (EMR) data. In some embodiments, recalculation delay period events may be derived from clinical encounter data, for example a care provider noticed about a specific patient's insulin adherence may relate to their elevated H1AC score. This could imply that the risk score for this patient needs to be updated every six months, as there could be significant changes in their risk profile if their adherence becomes noncompliant. For a second patient, however, who is non-diabetic, the system may recommend updating yearly, as there is no equivalent medication adherence feature in the corresponding risk tensor data. In some embodiments, recalculation delay period events include at least one of graph-based events and history-based events. In some embodiments, determining the graph-based events comprises determining an event graph data object for the recalculation delay period; and determining, based at least in part on the event graph data object and using a graph-based machine learning model, one or more graph-based events for the recalculation delay period. In some embodiments, determining the history-based events comprises determining an event history data object (e.g., describing patient EMR) for the recalculation delay period; and determining, based at least in part on the event history data object, one or more history-based events for the recalculation delay period. In some embodiments, the set of recalculation delay period events include a recalculation delay period event that describes the absence of occurrence of any events deemed medically significant in at least a designated sub-period of a recalculation delay period (e.g., in all of the recalculation delay period event).

The term “event-based confidence score” may refer to a data entity that is configured to describe an estimated/calculated credibility score for a predicted risk score that is determined based at least in part on detected/recorded occurrence of a set of recalculation delay period events during a recalculation delay period that is associated with the predicted risk score. In some embodiments, the event-based confidence score describes a reduction in credibility of a predicted risk score that results from occurrence of a set of recalculation delay period events during a recalculation delay period that is associated with the predicted risk score. In some embodiments, determining the event-based confidence score comprises detecting the one or more recalculation delay period events associated with the recalculation delay period; for each recalculation delay period event, determining an event weight based at least in part on an event weighting scheme for the target risk category; and determining the event-based confidence score based at least in part on each event weighting scheme. In some of the noted embodiments, determining the event weight for a particular recalculation delay period event comprises determining an initial event weight for the particular recalculation delay period event based at least in part on the event weighting scheme for the target risk category; determining an event weight adjustment value for the particular recalculation delay period based at least in part on a recalculation delay period event timestamp for the particular recalculation delay period event; and determining the event weight based at least in part on the initial event weight and the event weight adjustment value.

The term “event weighting scheme” may refer to a data entity that is configured to describe, for each recalculation delay period event from a set of recalculation delay period events, an estimated/computed significance of occurrence of the recalculation delay period event to determining an event-based confidence score for a predicted risk score that is associated with a target risk category, where the event weighting scheme is associated with the event weighting scheme. Thus, in at least some embodiments, the event weighting schemes for different event risk categories, as for example occurrence of an event may be deemed more significant to particular condition/disease than to a different condition/disease (e.g., an event of smoking may be deemed more significant to lung cancer risk than to diabetes risk). In some embodiments, each significance value described by an event weighting scheme is referred to as an event weight for the corresponding recalculation delay period event that is associated with the event weight to the risk category that is associated with the event weighting scheme.

The term “event weight adjustment value” may refer to a data entity that is configured to describe a measure of recommended reduction in an event weight for a particular recalculation delay period event that is determined based at least in part on a recalculation delay period event timestamp for the particular recalculation delay period event. For example, the event weight adjustment value may describe how much an initial event weight for a particular recalculation delay period event should be reduced based at least in part on how far the timestamp for the particular recalculation delay period event is from the timestamp for a target temporal unit with respect to which a recalculation determination is being generated. As another example, the event weight adjustment value may describe how much an initial event weight for a particular recalculation delay period event should be reduced based at least in part on how far the timestamp for the particular recalculation delay period event is from the calculation timestamp for a predicted risk score with respect to which a recalculation determination is being generated. As yet another example, the event weight adjustment value may describe how much an initial event weight for a particular recalculation delay period event should be reduced based at least in part on both of: (i) how far the timestamp for the particular recalculation delay period event is from the timestamp for a target temporal unit with respect to which a recalculation determination is being generated, and (ii) how far the timestamp for the particular recalculation delay period event is from the calculation timestamp for a predicted risk score with respect to which a recalculation determination is being generated.

The term “hybrid confidence score” may refer to a data entity that is configured to describe an estimated/calculated credibility score for a predicted risk score that is determined based at least in part on both of: (i) a recalculation delay value for a recalculation delay period that is associated with the predicted risk score and a target temporal unit, and (ii) detected/recorded occurrence of a set of recalculation delay period events during a recalculation delay period that is associated with the predicted risk score. In some embodiments, the hybrid confidence score for a predicted risk score and a target time unit is determined based at least in part on a delay-based confidence score for the predicted risk score and the target time unit and an event-based confidence score for the predicted risk score and the target time unit. In some embodiments, determining the hybrid confidence score comprises determining a delay-based confidence score weight and an event-based confidence score weight for the target risk category; determining an adjusted delay-based confidence score based at least in part on the delay-based confidence score and the delay-based confidence score weight; determining an adjusted event-based confidence score based at least in part on the event-based confidence score and the event-based confidence score weight; and determining the hybrid confidence score based at least in part on the adjusted delay-based confidence score and the adjusted event-based confidence score.

The term “delay-based confidence score weight” may refer to data entity that is configured to describe a significance of a delay-based confidence score to determining the hybrid confidence score for a predicted risk score that is associated with a corresponding risk category. Thus, in some embodiments, each corresponding risk category is associated with a different delay-based confidence score weight, as for example different diseases/conditions may be associated with different significance measures for delay-based factors. For example, for certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor. In some embodiments, determining the hybrid confidence score comprises: determining an adjusted delay-based confidence score based at least in part on the delay-based confidence score and the delay-based confidence score weight; and determining the hybrid confidence score based at least in part on the adjusted delay-based confidence score.

The term “event-based confidence score weight” may refer to data entity that is configured to describe a significance of an event-based confidence score to determining the hybrid confidence score for a predicted risk score that is associated with a corresponding risk category. Thus, in some embodiments, each corresponding risk category is associated with a different event-based confidence score weight, as for example different diseases/conditions may be associated with different significance measures for event-based factors. For example, for certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor. In some embodiments, determining the hybrid confidence score comprises: determining an adjusted event-based confidence score based at least in part on the event-based confidence score and the event-based confidence score weight; and determining the hybrid confidence score based at least in part on the adjusted event-based confidence score.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

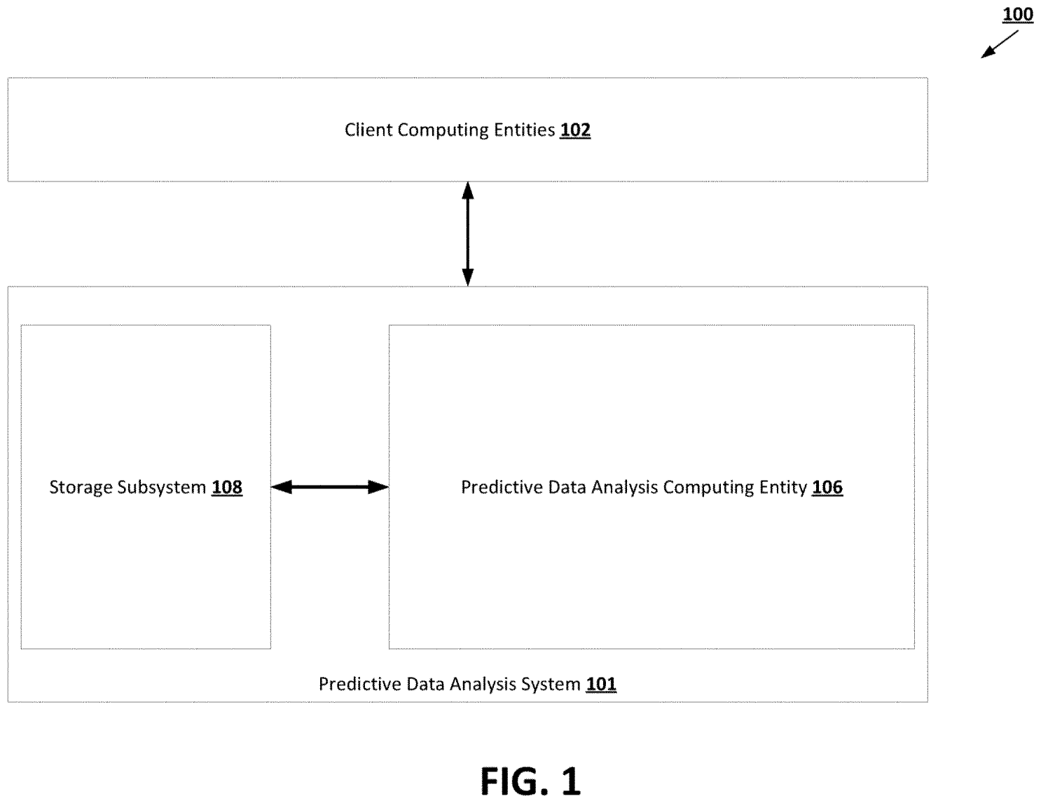

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions. An example of a prediction-based action that can be performed using the predictive data analysis system 101 is a request for generating a disease risk score based at least in part on at least one of patient genomic data, patient behavioral data, patient clinical data, and/or the like.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

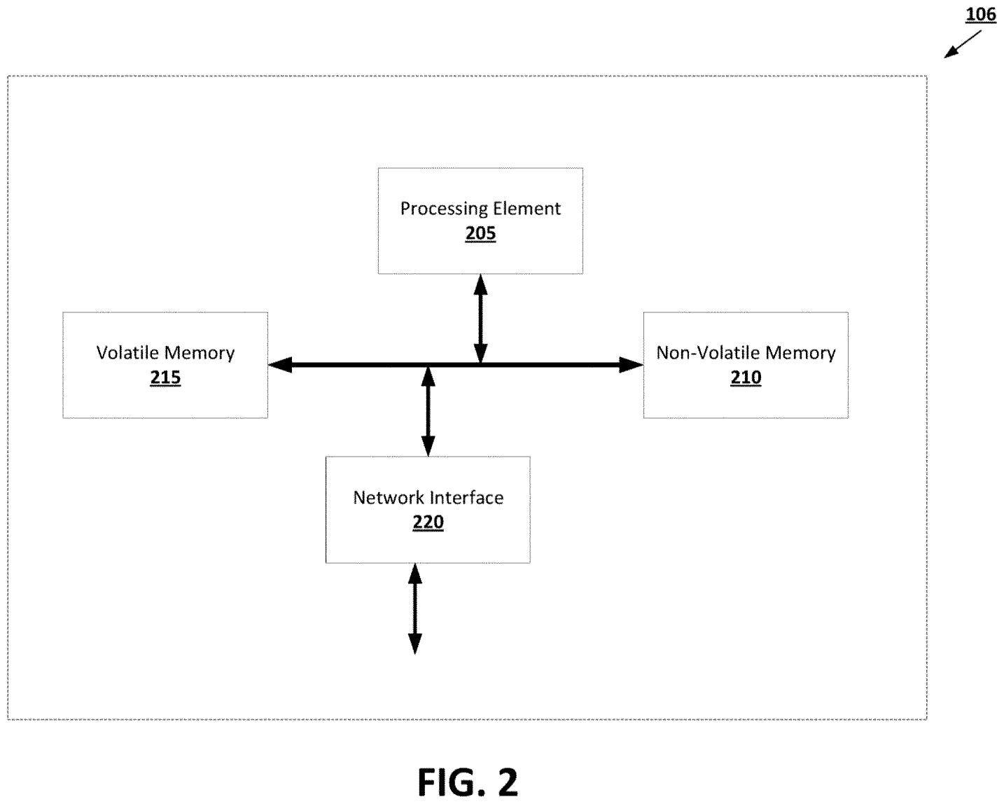

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

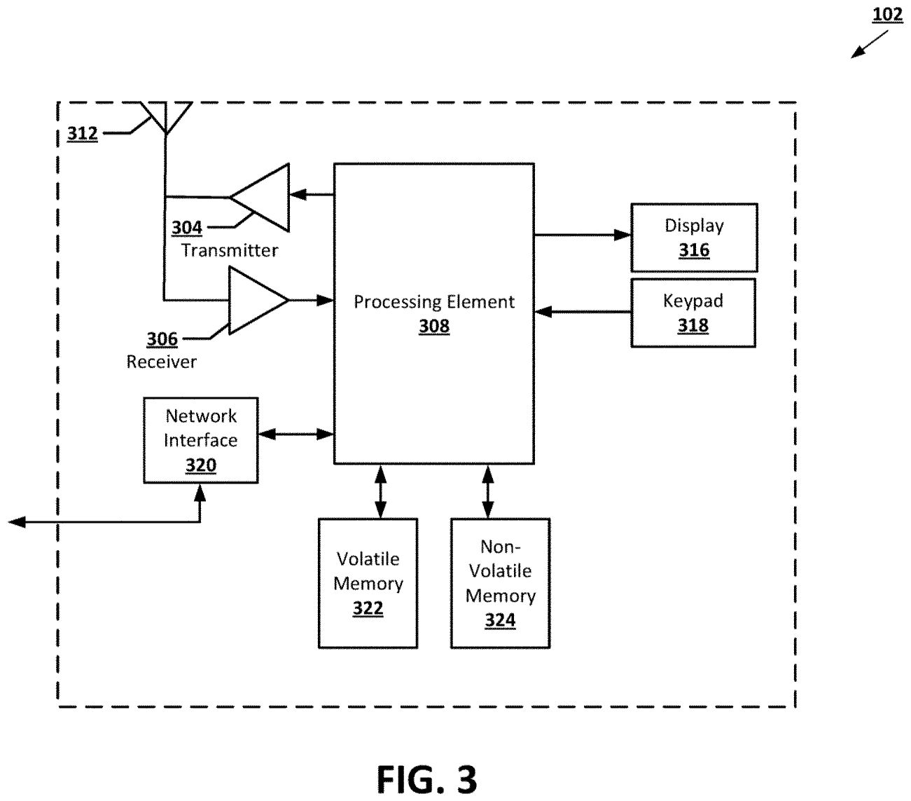

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As discussed below, various embodiments of the present invention improve the computational efficiency of performing risk score generation predictive data analysis by reducing the need for continuous generation of predicted risk scores. For example, various embodiments of the present invention introduce techniques to determine when to optimally recalculate predicted risk scores by using hybrid confidence scores for predicted risk scores based at least in part on delay-based confidence scores for the predicted risk scores and event-based confidence scores for the predicted risk scores. By using the noted techniques, various embodiments of the present invention reduce the number of times predicted risk scores need to be calculated, a feature that in turn avoids the need for some computational operations configured to recalculate predicted risk scores, and in doing so vastly improves the computational efficiency of performing risk score generation predictive data analysis by reducing the need for continuous generation of predicted risk scores.

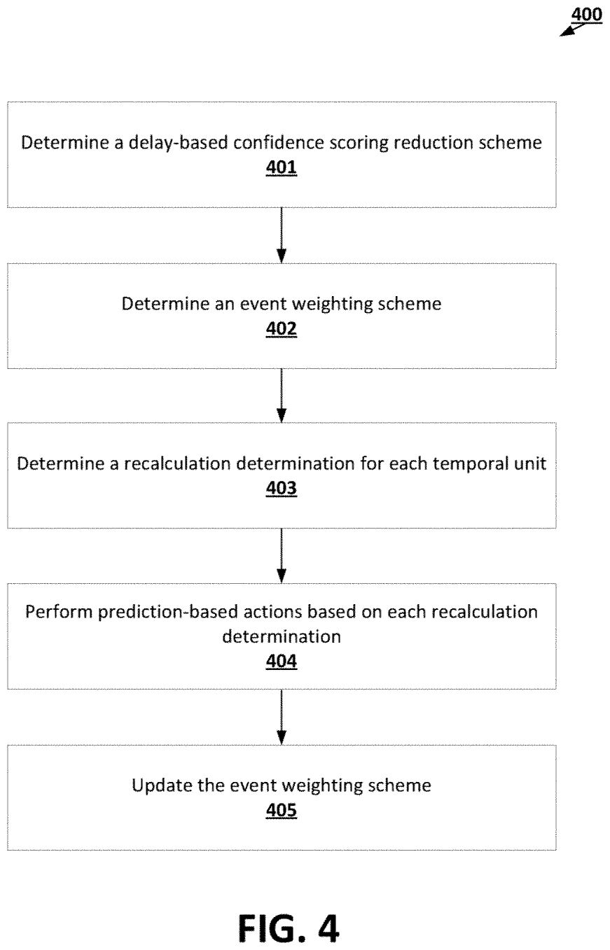

FIG. 4 is a flowchart diagram of an example process 400 for determining when to recalculate a predicted risk score for a target risk category (e.g., a target condition/disease). Via the various steps/operations of the process 400, the predictive data analysis computing entity 106 can increase the efficiency of a predictive data analysis system 101 that is configured to perform predicted risk score calculation by reducing the need for continuous predicted risk score calculation.

The process 400 begins at step/operation 401 when the predictive data analysis computing entity 106 determines a delay-based confidence scoring reduction scheme for the target risk category. In some embodiments, step/operation 401 includes determining the associated time period for which a typical re-calculation of the risk score would be advised, by data-driven decision making personalized for an individual patient being considered. In some embodiments, the associated time period is determined based at least in part on occurrence of suggested events that may also warrant a re-calculation of the risk score, e.g., a patient's increased HbA1c would most likely indicate poor compliance with insulin regime, in the case of a patient with T1D.

In some embodiments, the delay-based confidence scoring reduction scheme describes, for each recalculation delay value of a set of recalculation delay values, a measure of reduction in a total hybrid confidence score for a predicted risk score given the recalculation delay value, where the total hybrid confidence score is an upper bound of a hybrid confidence score (e.g., may be a hybrid confidence score of one), and where the total hybrid confidence score is associated with a target risk category that is in turn associated with the delay-based confidence scoring reduction scheme. For example, the delay-based confidence scoring reduction scheme may describe that, for a particular target risk category (e.g., for a particular disease/condition), a one-month recalculation delay value will cause a 0.1 reduction in a total hybrid confidence score of 1.0 for predicted risk scores that are associated with the particular target risk category; and that a two-month recalculation delay value will cause a 0.2 reduction in a total hybrid confidence score of 1.0 for predicted risk scores that are associated with the particular target risk category.

In some embodiments, the delay-based confidence scoring reduction scheme describes a function ƒ(x), where x varies over a set of recalculation delay values, and ƒ(x) describes, for each recalculation delay value, a measure of reduction in a total hybrid confidence score for a predicted risk score given the recalculation delay value. In some embodiments, a delay-based confidence scoring reduction scheme is a model that is specific to a particular target risk category, because predicted risk scores for different diseases/conditions have varying levels of susceptibility to losing relevance as a result of passage of times. For certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor.

In some embodiments, a recalculation delay value is a measure of time length of a recalculation delay period, which may be a time period between a calculation temporal unit timestamp for a predicted risk score that is associated with the recalculation delay period and a target temporal unit timestamp for a target temporal unit that is associated with the recalculation delay period. For example, if a predicted risk score is calculated on May 5, 2021, at a target temporal unit of Jul. 5, 2021, the recalculation delay period is the period between May 5, 2021 and Jul. 5, 2021, which may be associated with a recalculation delay period value of 61 days. As another example, if a predicted risk score is calculated on May 5, 2021 at 10:00 AM, at a target temporal unit of Jul. 5, 2021 of 12:00 PM, the recalculation delay period is the time period between May 5, 2021 at 10:00 AM and Jul. 5, 2021 at 12:00 PM, which may be associated with a recalculation delay period value of 61 days and two hours. In some embodiments, a recalculation delay period is associated with a recalculation delay period value that may be a measure of a length of time for the time period described by a recalculation delay period. In some embodiments, the recalculation delay period value for a recalculation delay period associated with a predicted risk score and a target temporal unit is used to determine the delay-based confidence score for the predicted risk score and the target temporal unit, where the delay-based confidence score is then in turn used to determine a hybrid confidence score for the predicted risk score and the target temporal unit.

At step/operation 402, the predictive data analysis computing entity 106 determines an event weighting scheme for the target risk category. The event weighting scheme may identify a set of potential recalculation delay period events that may occur for the target risk category, as well as an event weight for each recalculation delay period event.

In some embodiments, an event weighting scheme describes, for each recalculation delay period event from a set of recalculation delay period events, an estimated/computed significance of occurrence of the recalculation delay period event to determining an event-based confidence score for a predicted risk score that is associated with a target risk category, where the event weighting scheme is associated with the event weighting scheme. Thus, in at least some embodiments, the event weighting schemes for different event risk categories, as for example occurrence of an event may be deemed more significant to particular condition/disease than to a different condition/disease (e.g., an event of smoking may be deemed more significant to lung cancer risk than to diabetes risk). In some embodiments, each significance value described by an event weighting scheme is referred to as an event weight for the corresponding recalculation delay period event that is associated with the event weight to the risk category that is associated with the event weighting scheme.

In some embodiments, step/operation 402 further comprises generating one or more machine learning models to detect recalculation delay period events based at least in part on data describing recalculation delay periods. For example, in some embodiments, the one or more machine learning models may comprise a graph-based machine learning model that is configured to determine graph-based events for a recalculation delay period based at least in part on an event graph data object for the recalculation delay period. In some embodiments, generating each of the described machine learning models comprises training the machine learning model and validating the machine learning model. In some embodiments, generating a machine learning model comprises: (i) deploying the machine learning model on target datasets, after an initial check that key data items (e.g., whole genome sequencing (WGS) data, biomarkers, clinical encounter data, drug prescriptions, and/or the like) are available in sufficient volumes, completeness, and quality for the tool to be effective; and (ii) validating an initial run of the tool by partitioning hold-out data and validating that the tool meets the accuracy threshold, e.g., by partitioning sub-cohort of T1D patients via hold-out data and executing a predictive inference to confirm that the predicted risk scores generated using the trained machine learning models satisfy desired accuracy metrics.

At step/operation 403, the predictive data analysis computing entity 106 determines a recalculation determination for each temporal unit of a set of temporal units. For example, the predictive data analysis computing entity 106 may, beginning with a first temporal unit whose temporal unit timestamp is immediately after the calculation timestamp of the predicted risk score, continue determining recalculation determinations for temporal units in a sequential manner until a first temporal unit whose recalculation determination is an affirmative recalculation determination.

In some embodiments, a recalculation determination describes describe whether a predicted risk score for a target risk category should be recalculated at a target temporal unit (e.g., at a particular point in time) that is associated with the recalculation determination. In some embodiments, when a recalculation determination for a target risk category and a target temporal unit describes that the predicted risk score for the target risk category should be recalculated at the target temporal unit, the recalculation determination is referred to herein as an affirmative recalculation determination. In some embodiments, when a recalculation determination for a target risk category and a target temporal unit describes that the predicted risk score for the target risk category should not be recalculated at the target temporal unit, the recalculation determination is referred to herein as a negative recalculation determination. In some embodiments, a recalculation determination for a target risk category and a target temporal unit is determined based at least in part on a hybrid confidence score for the target risk category and the target temporal unit, where the hybrid confidence score for the target risk category and the target temporal unit may be determined based at least in part on a delay-based confidence score for the target risk category and the target temporal unit and an event-based confidence score for the target risk category and the target temporal unit. For example, in some embodiments, an affirmative recalculation determination is generated for a target risk category and a target temporal unit if the hybrid confidence score for the target risk category and the target temporal unit satisfies a hybrid confidence score threshold (e.g., exceeds the hybrid confidence score threshold, is above or equal to the hybrid confidence score threshold, and/or the like). As another example, a negative recalculation determination is generated for a target risk category and a target temporal unit if the hybrid confidence score for the target risk category and the target temporal unit fails to satisfy a hybrid confidence score threshold (e.g., is below or equal to the hybrid confidence score threshold, is below the hybrid confidence score threshold, and/or the like).

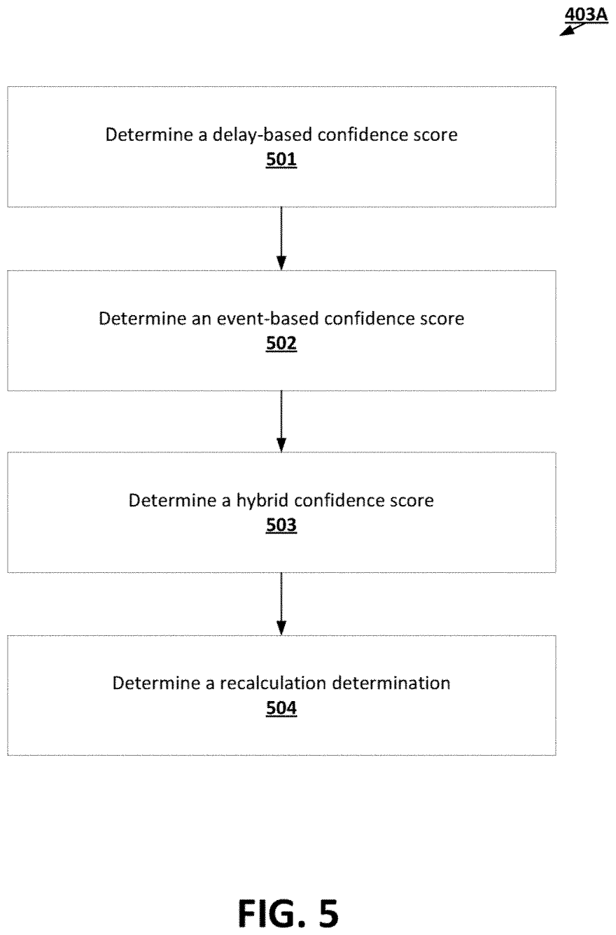

In some embodiments, step/operation 403 includes performing process 403A that is depicted in FIG. 5 for each target temporal unit in a set of temporal units, where process 403A is an example process for determining a recalculation determination for a target temporal unit. The process 403A begins at step/operation 501 when the predictive data analysis computing entity 106 determines a delay-based confidence score for the predicted risk score with respect to the target temporal unit.

In some embodiments, a delay-based confidence score describes describe an estimated/calculated credibility score for a predicted risk score that is determined based at least in part on a recalculation delay value for a recalculation delay period that is associated with the predicted risk score and a target temporal unit. In some embodiments, the delay-based confidence score describes a degree of reduction in the credibility of a predicted risk score that is resulting from mere passage of time from the timestamp associated with calculation of the predicted risk score. In some embodiments, a delay-based confidence score for a predicted risk score and a target temporal unit is determined based at least in part on a length of time from the calculation timestamp of the predicted risk score to a timestamp of the target temporal unit. In some embodiments, a delay-based confidence score for a predicted risk score that is associated with a target risk category is determined based at least in part on a delay-based confidence scoring reduction scheme for the target risk category, which may be a data entity describing, for each recalculation delay value of a set of recalculation delay values, a measure of reduction in a total hybrid confidence score for a predicted risk score given the recalculation delay value, where the total hybrid confidence score is an upper bound of a hybrid confidence score (e.g., may be a hybrid confidence score of one), and where the total hybrid confidence score is associated with a target risk category that is in turn associated with the delay-based confidence scoring reduction scheme.

For example, the delay-based confidence scoring reduction scheme may describe that, for a particular target risk category (e.g., for a particular disease/condition), a one-month recalculation delay value will cause a 0.1 reduction in a total hybrid confidence score of 1.0 for predicted risk scores that are associated with the particular target risk category; and that a two-month recalculation delay value will cause a 0.2 reduction in a total hybrid confidence score of 1.0 for predicted risk scores that are associated with the particular target risk category. In some embodiments, the delay-based confidence scoring reduction scheme describes a function ƒ(x), where x varies over a set of recalculation delay values, and ƒ(x) describes, for each recalculation delay value, a measure of reduction in a total hybrid confidence score for a predicted risk score given the recalculation delay value.

At step/operation 502, the predictive data analysis computing entity 106 determines an event-based confidence score for the predicted risk score with respect to the target temporal unit. In some embodiments, to determine the event-based confidence score for the predicted risk score with respect to the target temporal unit, the predicted data analysis computing entity 106 first determines a recalculation delay period for the target temporal unit, then determines one or more recalculation delay period events that have occurred in the recalculation delay period, then determines an event weight for each recalculation delay period event, and then combines each event weight to determine the event-based confidence score.

In some embodiments, an event-based confidence score describes an estimated/calculated credibility score for a predicted risk score that is determined based at least in part on detected/recorded occurrence of a set of recalculation delay period events during a recalculation delay period that is associated with the predicted risk score. In some embodiments, the event-based confidence score describes a reduction in credibility of a predicted risk score that results from occurrence of a set of recalculation delay period events during a recalculation delay period that is associated with the predicted risk score. In some embodiments, determining the event-based confidence score comprises detecting the one or more recalculation delay period events associated with the recalculation delay period; for each recalculation delay period event, determining an event weight based at least in part on an event weighting scheme for the target risk category; and determining the event-based confidence score based at least in part on each event weighting scheme. In some of the noted embodiments, determining the event weight for a particular recalculation delay period event comprises determining an initial event weight for the particular recalculation delay period event based at least in part on the event weighting scheme for the target risk category; determining an event weight adjustment value for the particular recalculation delay period based at least in part on a recalculation delay period event timestamp for the particular recalculation delay period event; and determining the event weight based at least in part on the initial event weight and the event weight adjustment value.

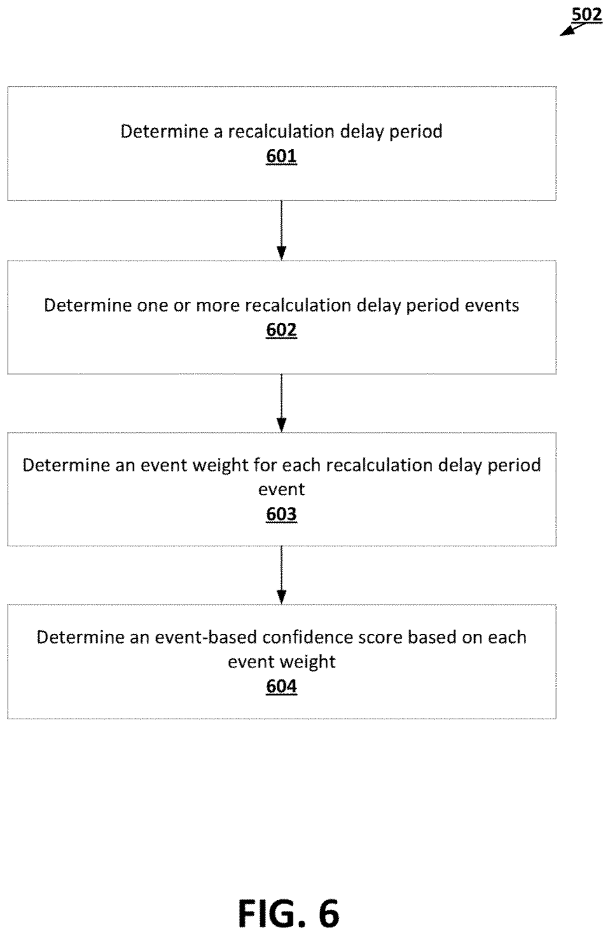

In some embodiments, step/operation 502 may be performed in accordance with the process that is depicted in FIG. 6, which is an example process for determining an event-based confidence score for the predicted risk score with respect to the target temporal unit. The process that is depicted in FIG. 6 begins at step/operation 601 when the predictive data analysis computing entity 106 determines a recalculation delay period for the target temporal unit, which may describe a time period between a calculation temporal unit timestamp for a predicted risk score that is associated with the recalculation delay period and a target temporal unit timestamp for a target temporal unit that is associated with the recalculation delay period. For example, if a predicted risk score is calculated on May 5, 2021, at a target temporal unit of Jul. 5, 2021, the recalculation delay period is the period between May 5, 2021 and Jul. 5, 2021, which may be associated with a recalculation delay period value of 61 days. As another example, if a predicted risk score is calculated on May 5, 2021 at 10:00 AM, at a target temporal unit of Jul. 5, 2021 of 12:00 PM, the recalculation delay period is the time period between May 5, 2021 at 10:00 AM and Jul. 5, 2021 at 12:00 PM, which may be associated with a recalculation delay period value of 61 days and two hours.

At step/operation 602, the predictive data analysis computing entity 106 determines one or more recalculation delay period events that have occurred in the recalculation delay period. In some embodiments, a recalculation delay period event describes a detected/recorded event whose occurrence is deemed related to credibility of a predicted risk score. For example, an applicable recalculation delay period event for a predicted risk score that is associated with calculation of potential hemorrhage risk for a patient who is being commenced on anticoagulant therapy is detection of indications that the patient may have a previous undiagnosed condition of factor V Leiden, due to a strong family history of abnormal blood clots, from the patient's electronic medical record (EMR) data. In some embodiments, recalculation delay period events may be derived from clinical encounter data, for example a care provider noticed about a specific patient's insulin adherence may relate to their elevated H1AC score. This could imply that the risk score for this patient needs to be updated every six months, as there could be significant changes in their risk profile if their adherence becomes noncompliant. For a second patient, however, who is non-diabetic, the system may recommend updating yearly, as there is no equivalent medication adherence feature in the corresponding risk tensor data. In some embodiments, recalculation delay period events include at least one of graph-based events and history-based events.

In some embodiments, determining the graph-based events comprises determining an event graph data object for the recalculation delay period; and determining, based at least in part on the event graph data object and using a graph-based machine learning model (e.g., the graph-based machine learning model generated in accordance with the techniques described above), one or more graph-based events for the recalculation delay period. In some embodiments, determining the history-based events comprises determining an event history data object (e.g., describing patient EMR) for the recalculation delay period; and determining, based at least in part on the event history data object, one or more history-based events for the recalculation delay period. In some embodiments, the set of recalculation delay period events include a recalculation delay period event that describes the absence of occurrence of any events deemed medically significant in at least a designated sub-period of a recalculation delay period (e.g., in all of the recalculation delay period event).

At step/operation 603, the predictive data analysis computing entity 106 determines an event weight for each recalculation delay period event. The event weight for a recalculation delay period event may describe an estimated/computed significance of the recalculation delay period event to credibility of the predicted risk score. In some embodiments, determining the event weight for a particular recalculation delay period event comprises determining an initial event weight for the particular recalculation delay period event based at least in part on the event weighting scheme for the target risk category; determining an event weight adjustment value for the particular recalculation delay period based at least in part on a recalculation delay period event timestamp for the particular recalculation delay period event; and determining the event weight based at least in part on the initial event weight and the event weight adjustment value. In some of the noted embodiments, an event weighting scheme describes, for each recalculation delay period event from a set of recalculation delay period events, an estimated/computed significance of occurrence of the recalculation delay period event to determining an event-based confidence score for a predicted risk score that is associated with a target risk category, where the event weighting scheme is associated with the event weighting scheme.

Thus, in at least some embodiments, the event weighting schemes for different event risk categories, as for example occurrence of an event may be deemed more significant to particular condition/disease than to a different condition/disease (e.g., an event of smoking may be deemed more significant to lung cancer risk than to diabetes risk). In some embodiments, each significance value described by an event weighting scheme is referred to as an event weight for the corresponding recalculation delay period event that is associated with the event weight to the risk category that is associated with the event weighting scheme.

As described above, an event weight for a recalculation delay period event may be determined based at least in part on an initial weight for the recalculation delay period event and an event weight adjustment value for the recalculation delay period event. In some embodiments, an event weight adjustment value is a measure of recommended reduction in an event weight for a particular recalculation delay period event that is determined based at least in part on a recalculation delay period event timestamp for the particular recalculation delay period event. For example, the event weight adjustment value may describe how much an initial event weight for a particular recalculation delay period event should be reduced based at least in part on how far the timestamp for the particular recalculation delay period event is from the timestamp for a target temporal unit with respect to which a recalculation determination is being generated. As another example, the event weight adjustment value may describe how much an initial event weight for a particular recalculation delay period event should be reduced based at least in part on how far the timestamp for the particular recalculation delay period event is from the calculation timestamp for a predicted risk score with respect to which a recalculation determination is being generated. As yet another example, the event weight adjustment value may describe how much an initial event weight for a particular recalculation delay period event should be reduced based at least in part on both of: (i) how far the timestamp for the particular recalculation delay period event is from the timestamp for a target temporal unit with respect to which a recalculation determination is being generated, and (ii) how far the timestamp for the particular recalculation delay period event is from the calculation timestamp for a predicted risk score with respect to which a recalculation determination is being generated.

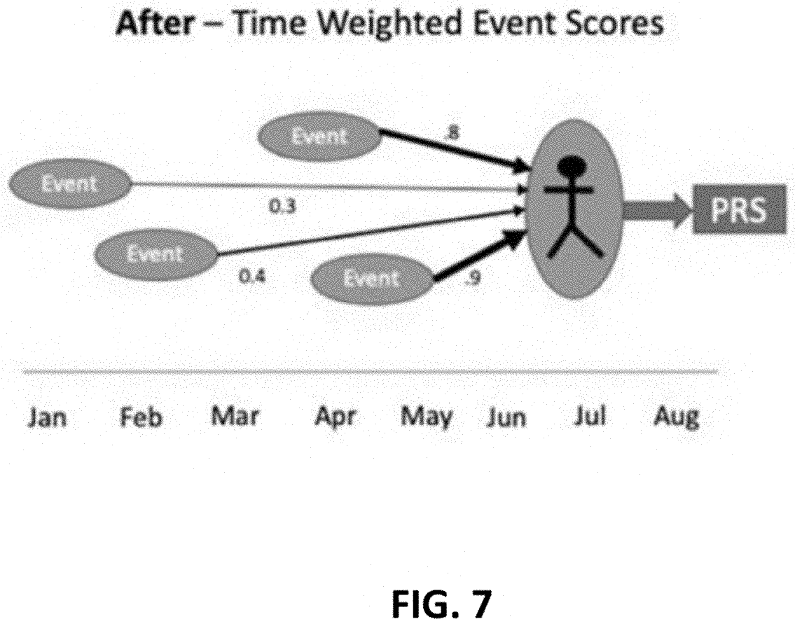

An operational example of a set of event weights for a set of recalculation delay period events is depicted in FIG. 7. As depicted in FIG. 7, the set of recalculation delay period events comprises four recalculation delay period events, where a first recalculation delay period event is associated with the event weight of 0.8, a second recalculation delay period event is associated with the event weight of 0.3, a third recalculation delay period event is associated with the event weight of 0.4, and a fourth recalculation delay period event is associated with the event weight of 0.9.

At step/operation 604, the predictive data analysis computing entity 106 determines the event-based confidence score based at least in part on each event weight. In some embodiments, the predictive data analysis computing entity 106 combines (e.g., averages, calculates a centroid measure such as a mean, a median, or a mode of, and/or the like) each event weight for an recalculation delay period event in order to generate the event-based confidence score.

Returning to FIG. 5, at step/operation 503, the predictive data analysis computing entity 106 determines the hybrid confidence score based at least in part on the delay-based confidence score and the event-based confidence score. In some embodiments, the predictive data analysis computing entity 106 combines (e.g., averages, calculates a centroid measure such as a mean, a median, or a mode of, and/or the like) the delay-based confidence score and the event-based confidence score to determine the hybrid confidence score.

In some embodiments, the hybrid confidence score is an estimated/calculated credibility score for a predicted risk score that is determined based at least in part on both of: (i) a recalculation delay value for a recalculation delay period that is associated with the predicted risk score and a target temporal unit, and (ii) detected/recorded occurrence of a set of recalculation delay period events during a recalculation delay period that is associated with the predicted risk score. In some embodiments, the hybrid confidence score for a predicted risk score and a target time unit is determined based at least in part on a delay-based confidence score for the predicted risk score and the target time unit and an event-based confidence score for the predicted risk score and the target time unit. In some embodiments, determining the hybrid confidence score comprises determining a delay-based confidence score weight and an event-based confidence score weight for the target risk category; determining an adjusted delay-based confidence score based at least in part on the delay-based confidence score and the delay-based confidence score weight; determining an adjusted event-based confidence score based at least in part on the event-based confidence score and the event-based confidence score weight; and determining the hybrid confidence score based at least in part on the adjusted delay-based confidence score and the adjusted event-based confidence score.

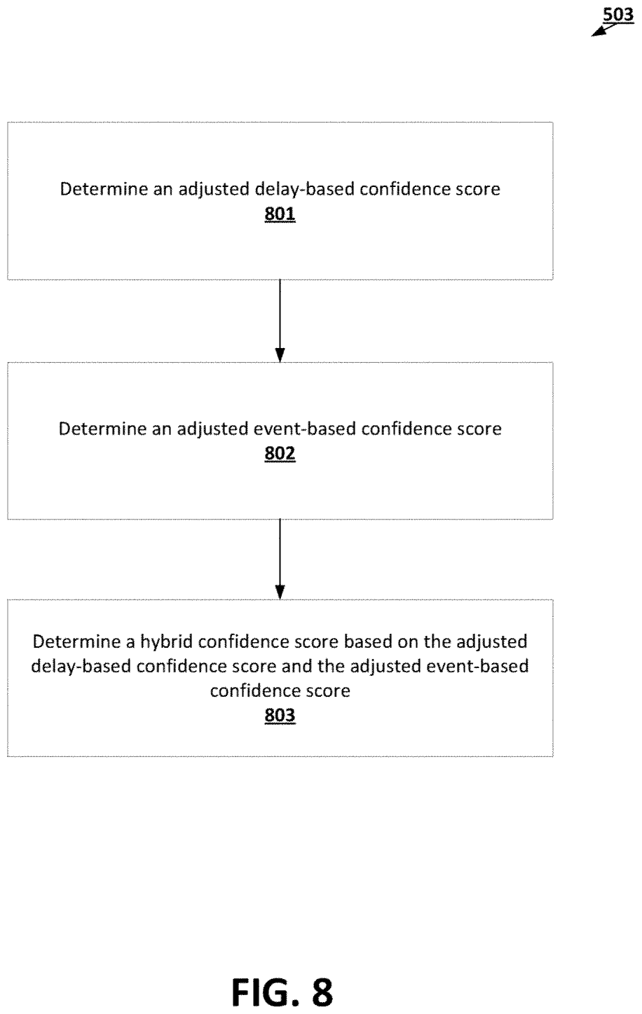

In some embodiments, step/operation 503 may be performed in accordance with the process that is depicted in FIG. 8, which is an example process for determining a hybrid confidence score for a predicted risk score with respect to a target temporal unit based at least in part on the delay-based confidence score for the predicted risk score with respect to the target temporal unit and the event-based confidence score for the predicted risk score with respect to the target temporal unit. The process that is depicted in FIG. 8 begins at step/operation 801 when the predicted data analysis computing entity 106 determines an adjusted delay-based confidence score by applying a delay-based confidence score weight to the delay-based confidence score. In some embodiments, the delay-based confidence score weight describes a significance of a delay-based confidence score to determining the hybrid confidence score for a predicted risk score that is associated with a corresponding risk category. Thus, in some embodiments, each corresponding risk category is associated with a different delay-based confidence score weight, as for example different diseases/conditions may be associated with different significance measures for delay-based factors. For example, for certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor. In some embodiments, determining the hybrid confidence score comprises: determining an adjusted delay-based confidence score based at least in part on the delay-based confidence score and the delay-based confidence score weight; and determining the hybrid confidence score based at least in part on the adjusted delay-based confidence score.

At step/operation 802, the predictive data analysis computing entity 106 determines an adjusted event-based confidence score by applying an event-based confidence score weight to the event-based confidence score. In some embodiments, the event-based confidence score weight describes a significance of an event-based confidence score to determining the hybrid confidence score for a predicted risk score that is associated with a corresponding risk category. Thus, in some embodiments, each corresponding risk category is associated with a different event-based confidence score weight, as for example different diseases/conditions may be associated with different significance measures for event-based factors. For example, for certain risk scores, regardless of what the user does, time may be the only factor that determines when the risk score is recreated. An example might be the trajectory of development for a patient who has been deemed at high risk of early-onset Alzheimer's disease, where non-genetic risk factors may be deemed small compared to the patient's genetic profile and their age, and thus the time period since the initial risk score is the most likely factor. In some embodiments, determining the hybrid confidence score comprises: determining an adjusted event-based confidence score based at least in part on the event-based confidence score and the event-based confidence score weight; and determining the hybrid confidence score based at least in part on the adjusted event-based confidence score.

At step/operation 803, the predictive data analysis computing entity 106 determines the hybrid confidence score based at least in part on the adjusted delay-based confidence score and the adjusted event-based confidence score. In some embodiments, the predictive data analysis computing entity 106 combines (e.g., averages, calculates a centroid measure such as a mean, a median, or a mode of, and/or the like) the adjusted delay-based confidence score and the adjusted event-based confidence score to determine the hybrid confidence score.

Returning to FIG. 5, at step/operation 504, the predictive data analysis computing entity 106 determines the recalculation determination based at least in part on the hybrid confidence score. In some embodiments, when a recalculation determination for a target risk category and a target temporal unit describes that the predicted risk score for the target risk category should be recalculated at the target temporal unit, the recalculation determination is referred to herein as an affirmative recalculation determination. In some embodiments, when a recalculation determination for a target risk category and a target temporal unit describes that the predicted risk score for the target risk category should not be recalculated at the target temporal unit, the recalculation determination is referred to herein as a negative recalculation determination. In some embodiments, a recalculation determination for a target risk category and a target temporal unit is determined based at least in part on a hybrid confidence score for the target risk category and the target temporal unit, where the hybrid confidence score for the target risk category and the target temporal unit may be determined based at least in part on a delay-based confidence score for the target risk category and the target temporal unit and an event-based confidence score for the target risk category and the target temporal unit.

In some embodiments, an affirmative recalculation determination is generated for a target risk category and a target temporal unit if the hybrid confidence score for the target risk category and the target temporal unit satisfies a hybrid confidence score threshold (e.g., exceeds the hybrid confidence score threshold, is above or equal to the hybrid confidence score threshold, and/or the like). As another example, a negative recalculation determination is generated for a target risk category and a target temporal unit if the hybrid confidence score for the target risk category and the target temporal unit fails to satisfy a hybrid confidence score threshold (e.g., is below or equal to the hybrid confidence score threshold, is below the hybrid confidence score threshold, and/or the like).

By using the techniques described in relation to step/operation 403, various embodiments of the present invention improve the computational efficiency of performing risk score generation predictive data analysis by reducing the need for continuous generation of predicted risk scores. For example, various embodiments of the present invention introduce techniques to determine when to optimally recalculate predicted risk scores by using hybrid confidence scores for predicted risk scores based at least in part on delay-based confidence scores for the predicted risk scores and event-based confidence scores for the predicted risk scores. By using the above-described techniques, various embodiments of the present invention reduce the number of times predicted risk scores need to be calculated, a feature that in turn avoids the need for some computational operations configured to recalculate predicted risk scores, and in doing so vastly improves the computational efficiency of performing risk score generation predictive data analysis by reducing the need for continuous generation of predicted risk scores.

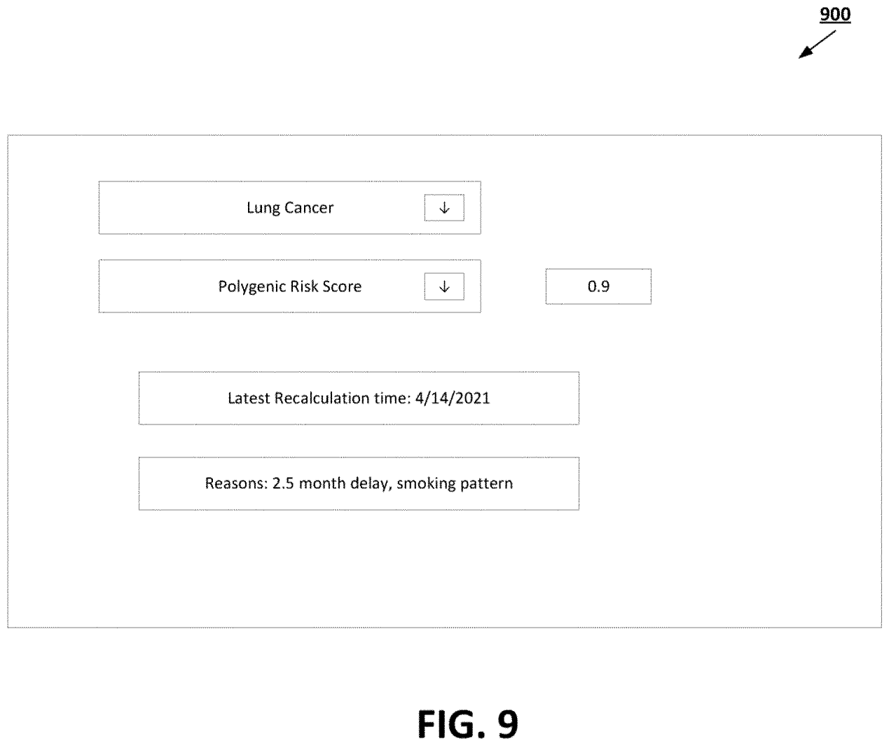

Returning to FIG. 4, at step/operation 404, the predictive data analysis computing entity 106 performs one or more prediction-based actions based at least in part on each recalculation determination for a target temporal unit. In some embodiments, the predictive data analysis computing entity 106 automatically recalculates the predicted risk score when the predictive data analysis computing entity 106 first detects a target temporal unit that is associated with an affirmative recalculation determination. In some embodiments, performing the one or more prediction-based actions comprises, in response to determining that the recalculation determination for a target temporal unit is an affirmative recalculation determination, determining a recalculated predicted risk score for the target risk category. In some embodiments, performing the prediction-based actions comprises displaying a prediction output user interface that describes the recalculated predicted risk score for a target risk category, the recalculation timestamp for the recalculated predicted risk score, and a set of recalculation reasons for the recalculated predicted risk score. An operational example of such a prediction output user interface 900 for the lung cancer risk category is depicted in FIG. 9.

At step/operation 405, the predictive data analysis computing entity 106 updates the event weighting scheme by adding new recalculation delay period events and event weights for each recalculation delay period event. In some embodiments, as part of the prediction process, a prediction model records features that have significant contribution to the overall risk (e.g., for non-small cell lung cancer (NSCLC), smoking pack history, and/or the like). The location of these fields are noted in the EMR so that the integrated risk-scoring tool can periodically scan the EMR database to determine when there are significant changes, e.g., medication adherence or other behaviors that may trigger a re-calculation alert. These alerts occur because the integrated risk-scoring tool will perform, if appropriate, an automated check on whether these fields in the EMR database have changed (e.g., periodic scan for updates or changes once per week). There is also the possibility of a circumstance whereby an existing WGS may need to be complimented by subsequent additional genetic tests. For example, in the treatment of NSCLC, the tumor itself may mutate to acquire certain single-nucleotide polymorphisms (SNPs) that are associated with resistance to certain anticancer drugs, such as the T790M mutation in the tumor EGFR gene that is associated with acquired resistance to Gefitinib. In certain cases, a panel is required to determine the appropriate drug.

Accordingly, as described above, various embodiments of the present invention improve the computational efficiency of performing risk score generation predictive data analysis by reducing the need for continuous generation of predicted risk scores. For example, various embodiments of the present invention introduce techniques to determine when to optimally recalculate predicted risk scores by using hybrid confidence scores for predicted risk scores based at least in part on delay-driven confidence scores for the predicted risk scores and event-driven confidence scores for the predicted risk scores. By using the noted techniques, various embodiments of the present invention reduce the number of times predicted risk scores need to be calculated, a feature that in turn avoids the need for some computational operations configured to recalculate predicted risk scores, and in doing so vastly improves the computational efficiency of performing risk score generation predictive data analysis by reducing the need for continuous generation of predicted risk scores.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining a recalculation determination for a predicted risk score that is associated with a target risk category with respect to a target temporal unit, the computer-implemented method comprising:
determining, using a processor and based at least in part on a recalculation delay value for a recalculation delay period that is associated with the target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category;
determining, using the processor and based at least in part on one or more recalculation delay period events associated with the recalculation delay period, an event-based confidence score for the target temporal unit;
determining, using the processor, a hybrid confidence score for the predicted risk score based at least in part on the delay-based confidence score and the event-based confidence score;
determining, using the processor, the recalculation determination based at least in part on whether the hybrid confidence score satisfies a hybrid confidence score threshold;
performing, using the processor, one or more prediction-based actions based at least in part on the recalculation determination.

2. The computer-implemented method of claim 1, wherein determining the event-based confidence score comprises:
detecting the one or more recalculation delay period events associated with the recalculation delay period;
for each recalculation delay period event, determining an event weight based at least in part on an event weighting scheme for the target risk category; and
determining the event-based confidence score based at least in part on each event weighting scheme.

3. The computer-implemented method of claim 2, wherein detecting the one or more recalculation delay period events comprises:
determining an event graph data object for the recalculation delay period;
determining, based at least in part on the event graph data object and using a graph-based machine learning model, one or more graph-based events for the recalculation delay period; and
determining the one or more recalculation delay period events based at least in part on the one or more graph-based events.

4. The computer-implemented method of claim 2, wherein detecting the one or more recalculation delay period events comprises:
determining an event history data object for the recalculation delay period;
determining, based at least in part on the event history data object, one or more history-based events for the recalculation delay period; and
determining the one or more recalculation delay period events based at least in part on the one or more history-based events.

5. The computer-implemented method of claim 2, wherein determining the event weight for a particular recalculation delay period event comprises:
determining an initial event weight for the particular recalculation delay period event based at least in part on the event weighting scheme for the target risk category;
determining an event weight adjustment value for the particular recalculation delay period based at least in part on a recalculation delay period event timestamp for the particular recalculation delay period event; and
determining the event weight based at least in part on the initial event weight and the event weight adjustment value

6. The computer-implemented method of claim 1, wherein determining the hybrid confidence score comprises:
determining a delay-based confidence score weight and an event-based confidence score weight for the target risk category;
determining an adjusted delay-based confidence score based at least in part on the delay-based confidence score and the delay-based confidence score weight;
determining an adjusted event-based confidence score based at least in part on the event-based confidence score and the event-based confidence score weight; and
determining the hybrid confidence score based at least in part on the adjusted delay-based confidence score and the adjusted event-based confidence score.

7. The computer-implemented method of claim 1, wherein performing the one or more prediction-based actions comprises:
in response to determining that the recalculation determination is an affirmative recalculation determination, determining a recalculated predicted risk score for the target risk category.

8. An apparatus for determining a recalculation determination for a predicted risk score that is associated with a target risk category with respect to a target temporal unit, the apparatus comprising at least one processor and at least one memory including program code, the at least one memory and the program code configured to, with the processor, cause the apparatus to at least:
determine, based at least in part on a recalculation delay value for a recalculation delay period that is associated with the target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category;
determine, based at least in part on one or more recalculation delay period events associated with the recalculation delay period, an event-based confidence score for the target temporal unit;
determine a hybrid confidence score for the predicted risk score based at least in part on the delay-based confidence score and the event-based confidence score;
determine the recalculation determination based at least in part on whether the hybrid confidence score satisfies a hybrid confidence score threshold;
perform one or more prediction-based actions based at least in part on the recalculation determination.

9. The apparatus of claim 8, wherein determining the event-based confidence score comprises:
detecting the one or more recalculation delay period events associated with the recalculation delay period;
for each recalculation delay period event, determining an event weight based at least in part on an event weighting scheme for the target risk category; and
determining the event-based confidence score based at least in part on each event weighting scheme.

10. The apparatus of claim 9, wherein detecting the one or more recalculation delay period events comprises:
determining an event graph data object for the recalculation delay period;
determining, based at least in part on the event graph data object and using a graph-based machine learning model, one or more graph-based events for the recalculation delay period; and
determining the one or more recalculation delay period events based at least in part on the one or more graph-based events.

11. The apparatus of claim 9, wherein detecting the one or more recalculation delay period events comprises:
determining an event history data object for the recalculation delay period;
determining, based at least in part on the event history data object, one or more history-based events for the recalculation delay period; and
determining the one or more recalculation delay period events based at least in part on the one or more history-based events.

12. The apparatus of claim 9, wherein determining the event weight for a particular recalculation delay period event comprises:
determining an initial event weight for the particular recalculation delay period event based at least in part on the event weighting scheme for the target risk category;
determining an event weight adjustment value for the particular recalculation delay period based at least in part on a recalculation delay period event timestamp for the particular recalculation delay period event; and
determining the event weight based at least in part on the initial event weight and the event weight adjustment value

13. The apparatus of claim 8, wherein determining the hybrid confidence score comprises:
determining a delay-based confidence score weight and an event-based confidence score weight for the target risk category;
determining an adjusted delay-based confidence score based at least in part on the delay-based confidence score and the delay-based confidence score weight;
determining an adjusted event-based confidence score based at least in part on the event-based confidence score and the event-based confidence score weight; and
determining the hybrid confidence score based at least in part on the adjusted delay-based confidence score and the adjusted event-based confidence score.

14. The apparatus of claim 8, wherein performing the one or more prediction-based actions comprises:
in response to determining that the recalculation determination is an affirmative recalculation determination, determining a recalculated predicted risk score for the target risk category.

15. A computer program product for determining a recalculation determination for a predicted risk score that is associated with a target risk category with respect to a target temporal unit, the computer program product comprising at least one non-transitory computer-readable storage medium having computer-readable program code portions stored therein, the computer-readable program code portions configured to:
determine, based at least in part on a recalculation delay value for a recalculation delay period that is associated with the target temporal unit, a delay-based confidence score for the target temporal unit, wherein: (i) the recalculation delay value is determined based at least in part on a calculation temporal unit timestamp for the predicted risk score and a target temporal unit timestamp for the target temporal unit, and (ii) the delay-based confidence score is determined based at least in part on a delay-based confidence scoring reduction scheme for the target risk category;
determine, based at least in part on one or more recalculation delay period events associated with the recalculation delay period, an event-based confidence score for the target temporal unit;
determine a hybrid confidence score for the predicted risk score based at least in part on the delay-based confidence score and the event-based confidence score;
determine the recalculation determination based at least in part on whether the hybrid confidence score satisfies a hybrid confidence score threshold;
perform one or more prediction-based actions based at least in part on the recalculation determination.

16. The computer program product of claim 15, wherein determining the event-based confidence score comprises:
detecting the one or more recalculation delay period events associated with the recalculation delay period;
for each recalculation delay period event, determining an event weight based at least in part on an event weighting scheme for the target risk category; and
determining the event-based confidence score based at least in part on each event weighting scheme.

17. The computer program product of claim 16, wherein detecting the one or more recalculation delay period events comprises:
determining an event graph data object for the recalculation delay period;
determining, based at least in part on the event graph data object and using a graph-based machine learning model, one or more graph-based events for the recalculation delay period; and
determining the one or more recalculation delay period events based at least in part on the one or more graph-based events.

18. The computer program product of claim 16, wherein detecting the one or more recalculation delay period events comprises:
determining an event history data object for the recalculation delay period;
determining, based at least in part on the event history data object, one or more history-based events for the recalculation delay period; and
determining the one or more recalculation delay period events based at least in part on the one or more history-based events.

19. The computer program product of claim 16, wherein determining the event weight for a particular recalculation delay period event comprises:
determining an initial event weight for the particular recalculation delay period event based at least in part on the event weighting scheme for the target risk category;
determining an event weight adjustment value for the particular recalculation delay period based at least in part on a recalculation delay period event timestamp for the particular recalculation delay period event; and
determining the event weight based at least in part on the initial event weight and the event weight adjustment value

20. The computer program product of claim 15, wherein determining the hybrid confidence score comprises:
determining a delay-based confidence score weight and an event-based confidence score weight for the target risk category;
determining an adjusted delay-based confidence score based at least in part on the delay-based confidence score and the delay-based confidence score weight;
determining an adjusted event-based confidence score based at least in part on the event-based confidence score and the event-based confidence score weight; and
determining the hybrid confidence score based at least in part on the adjusted delay-based confidence score and the adjusted event-based confidence score.
